(19) United States
(12) Patent Application Publication
(10) Pub. No.: US 2006/0279403 A1
(43) Pub. Date: Dec. 14, 2006

(54) Anti-theft securing method for hands-free vehicle access systems

(75) Inventor: Bernard Dattero, La Salvetat Saint Gilles (FR)

Correspondence Address: YOUNG & THOMPSON, 745 SOUTH 23RD STREET, 2ND FLOOR, ARLINGTON, VA, 22202, US

(73) Assignee: SIEMENS VDO AUTOMOTIVE, TOULOUSE CEDEX 1 (FR)

(21) Appl. No.: 11/450,296

(22) Filed: Jun. 12, 2006

(30) Foreign Application Priority Data
Jun. 13, 2005 (FR) 0505962

(51) Int. Cl. B60R 25/00

(52) U.S. Cl. 340/5.72; 340/5.61; 340/5.64

(57) ABSTRACT

An anti-theft securing method for a hands-free motor vehicle (V) access system including a central processing unit (4) installed in the vehicle and an associated remote control unit (B), the remote control unit including manually operated remote locking/unlocking devices (7, 8) and the central processing unit and the control unit including transmission elements (1-3, 6) capable of allowing them to have dialogue. The securing method includes establishing a specific access procedure according to which, when the locking is obtained by manual operation of the remote locking devices (8) of the control unit (B), then the unlocking is authorized only after an operation of the unlocking devices (7) of the control unit.

The invention relates to an anti-theft securing method for a hands-free motor vehicle access system. It extends to a hands-free access system implementing this method.

Hands-free motor vehicle access systems conventionally comprise a central processing unit installed in said vehicle and an associated remote control unit. The remote control unit comprises manually operated remote locking/unlocking devices. The central processing unit and the control unit comprise transmission means capable of allowing them to have dialogue for the purpose of implementing two alternative preprogrammed access procedures consisting:
in a semi-automatic procedure according to which the locking and/or the unlocking are obtained by manual operation of the remote locking/unlocking devices of the remote control unit, within a cover zone,
and in an automatic procedure according to which the unlocking results from an identification of a control unit by the central processing unit of the vehicle within a zone, called the opening zone, of predefined extent around said vehicle, and the locking results from the absence of a control unit within said opening zone.

One of the disadvantages of such access systems is the fact that in the automatic procedure, when a control unit is identified within the opening zone by the central processing unit of a vehicle, the doors of that vehicle are unlocked simply by operating the handles. In fact, it is therefore possible, in particular for a person with bad intentions, to open a door of the vehicle and to get into the latter if the control unit (electronic badge) is within the opening zone. Such a case can occur particularly if the badge (control unit) is left by its owner in an area close to the vehicle or when the person carrying the badge remains close to his vehicle. A thief can therefore take advantage of a moment of lack of attention by the person carrying the badge in order to open a door and get into the vehicle and start up.

The invention aims to overcome this disadvantage and its main purpose is to provide a securing method giving the possibility of locking of the doors of a vehicle even when a control unit is located within the opening zone of that vehicle.

For this purpose, the invention relates to an anti-theft securing method for a hands-free access system of the type described above, said securing method consisting of introducing, in addition to the previously mentioned two access procedures, semi-automatic and automatic respectively, a third access procedure according to which, when a locking is commanded by manual operation of the remote locking/unlocking devices of a control unit (badge) disposed in the opening zone, then the unlocking is authorized only after an operation of said unlocking devices of the control unit and not simply by operating the handles of the vehicle.

The method according to the invention therefore makes it possible to lock voluntarily the doors of a vehicle and to maintain the latter in their locked state, and to do so despite the possible presence of a control unit in the opening zone of that vehicle.

By prohibiting the unlocking of the vehicle simply by operating the handles (when the badge is located in the opening zone and if the locking has been requested by voluntary operation of the locking button of the badge), the driver is given the possibility of prohibiting access to his vehicle without his authorization. This is so even if the driver (and in particular his badge) is located in the opening zone. Moreover, this securing method is simple to implement since it suffices for the driver to lock his vehicle voluntarily by pressing the locking button on his remote control (badge).

Moreover, advantageously according to the invention and for the “comfort” of the user, this securing method consists in eliminating the obligation to unlock by manual operation of the unlocking devices imposed by the third access procedure, when there is detection, after a locking obtained by manual operation of the locking/unlocking devices, of a control unit moving outside of a zone, called the cover zone, of predefined extent around the vehicle and greater than that of the opening zone.

Thus, if the driver moves away from his vehicle sufficiently, (exiting from the cover zone) the conventional automatic opening procedure is reactivated. Because of this, when the driver returns to his vehicle, the driver does not find himself in front of a door which refuses to open on his approach, if he has forgotten that he had activated the securing procedure on his departure.

Moreover, for purposes of simplicity of use, the selected cover zone advantageously consists of the cover zone of the transmissions between the central processing unit of a vehicle and a remote control unit (badge).

The invention extends to a hands-free access system for a motor vehicle comprising a central processing unit designed to be installed in said vehicle and an associated remote control unit. According to the invention:
the remote control unit comprises manually operated remote locking/unlocking devices,
the central processing unit and the control unit comprise transmission means capable of allowing them to have dialogue,
and the central processing unit and the control unit are programmed for the purpose of implementing three alternative access authorization procedures consisting in:
   a semi-automatic procedure according to which the locking and/or the unlocking are obtained by manual operation of the remote locking/unlocking devices of the remote control unit within a cover zone,
   an automatic procedure according to which the unlocking results from an identification of a control unit by the central processing unit within a zone, called the opening zone, of predefined extent around the vehicle, and the locking results from the absence of a control unit within said opening zone,
   and an intermediate procedure called a securing procedure according to which, when the locking is obtained by manual operation of remote locking/unlocking devices of a control unit disposed in the opening zone, the unlocking can be carried out only by operating said unlocking devices of the control unit.

Other features, objectives and advantages of the invention will emerge from the following detailed description given with reference to the appended drawing which shows a preferred embodiment of it by way of nonlimiting example:

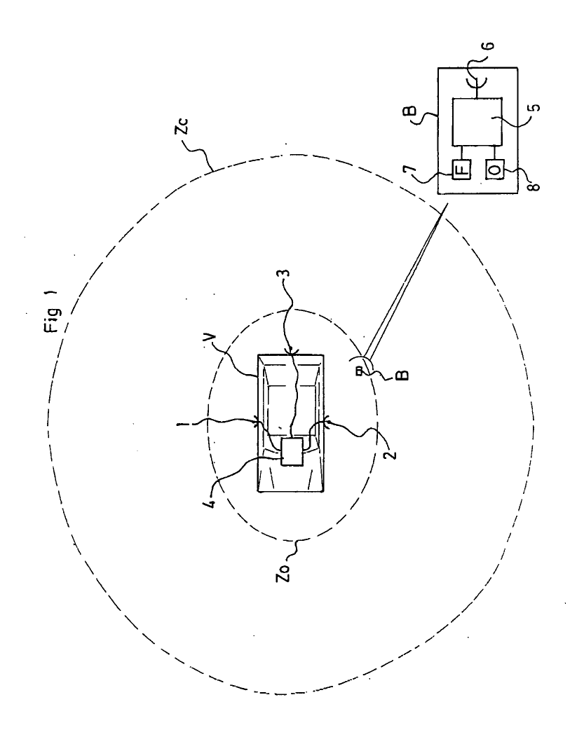

FIG. 1 (the sole FIGURE) consists of a diagrammatic plan view of a vehicle equipped with a hands-free access system according to the invention.

The device according to the invention shown by way of example in FIG. 1 equipping a vehicle V, consists in a device usually known as a “hands-free access system” adapted to make it possible to gain access to the vehicle V and possibly to start up the latter due to the identification of a portable remote control unit B commonly called an “electronic badge”.

In the usual manner, this hands-free access system comprises, firstly, antennas disposed inside (not shown) and outside, 1 to 3, of the vehicle V and connected to a central processing unit 4 installed in said vehicle and provided with a computer incorporating a low frequency “LF” transmitter and a radiofrequency “RF” receiver.

It should be noted that, for purposes of simplification, only three external antennas 1-3, in this example positioned on the side doors and on the trunk access door of the vehicle V, are shown in FIG. 1. However, the hands-free access device according to the invention also comprises, conventionally, internal antennas and an RF receiving antenna usually incorporated in the central processing unit 4.

The electronic badge B of this hands-free access system comprises a computer 5 incorporating a low frequency “LF” receiver and a radiofrequency “RF” transmitter connected to antennas such as 6.

This electronic badge B also comprises two buttons 7, 8 intended to make it possible to remotely control, by a manual action, the locking and the unlocking respectively of the doors of the vehicle V.

As shown in FIG. 1, such access devices are designed to delimit around a vehicle V:
a first zone Zo, called the opening zone, of extent defined by the low frequency “LF” transmitting means of the central processing unit 4,
and a second zone Zc, called the cover zone, corresponding to the cover zone of the transmissions between the central processing unit 4 of the vehicle V and an electronic badge B.

It should be noted that the opening Zo and cover Zc zones shown diagrammatically in FIG. 1 consist of theoretical zones corresponding to an environment that is undisturbed from the electromagnetic point of view.

Furthermore, according to the invention, these access devices are programmed in such a way as to implement three alternative access authorization procedures consisting in:
a semi-automatic procedure according to which the locking and/or the unlocking of the vehicle can be obtained, in the cover zone Vc, by manual operation of the buttons 7, 8 of the electronic badge B,
an automatic procedure according to which the unlocking results from an identification of an electronic badge B by the central processing unit 4 in the opening zone Zo, and the locking results from the absence of an electronic badge B in said opening zone,
and an intermediate procedure called a securing procedure according to which:
   when the locking is obtained by manual operation of the locking button 7 of an electronic badge B disposed in the opening zone Zo, the unlocking can be carried out only by operating the unlocking device 8 of the control unit B,
   this aforesaid obligation to unlock by manual operation of the unlocking button 8 is eliminated when the electronic badge B moves outside of the cover zone Zc; in this case the vehicle can be unlocked by operating a handle.

The access devices according to the invention are therefore programmed in such a way as to offer users the possibility of effectively locking the doors of a vehicle V when these users (badge carriers) are within the opening zone Zo of an electronic badge B.

1. Anti-theft securing method for a hands-free motor vehicle (V) access system comprising a central processing unit (4) installed in said vehicle and an associated remote control unit (B), said remote control unit comprising manually operated remote locking/unlocking devices (7, 8) and said central processing unit and said control unit comprising transmission means (1-3, 6) capable of allowing them to have dialogue for the purpose of implementing two alternative preprogrammed access procedures consisting:
in a semi-automatic procedure according to which the locking and/or the unlocking are obtained by manual operation of the remote locking/unlocking devices (7, 8) of the remote control unit (B) within a cover zone (Zc),
and in an automatic procedure according to which the unlocking results from an identification of a control unit (B) by the central processing unit (4) of the vehicle (V) within a zone (Zo), called the opening zone, of predefined extent around said vehicle, and the locking results from the absence of a control unit (B) within said opening zone,
said securing method being characterized in that it introduces a third access procedure according to which, when a locking is commanded by manual operation of the remote locking devices (8) of a control unit (B) disposed in the opening zone (Zo), then the unlocking is authorized only after an operation of said unlocking devices (7) of the control unit (B).

2. Securing method according to claim 1, characterized in that it consists in eliminating the obligation to unlock by manual operation of the unlocking devices (7) imposed by the third access procedure, when there is detection, after a locking obtained by manual operation of the locking devices (8), of a control unit (B) moving outside of a zone (Zc), called the cover zone, of predefined extent around the vehicle (V) and greater than that of the opening zone (Zo).

3. Securing method according to claim 2, characterized in that the selected cover zone (Zc) consists of the cover zone of the transmissions between the central processing unit (4) of a vehicle (V) and a remote control unit (B).

4. Hands-free access system for a motor vehicle comprising a central processing unit (4) designed to be installed in said vehicle and an associated remote control unit (B), characterized in that, in combination:
the remote control unit (B) comprises manually operated remote locking/unlocking devices (7, 8),
the central processing unit (4) and the control unit (B) comprise transmission means (1-3, 6) capable of allowing them to have dialogue,
and the central processing unit (4) and the control unit (B) are programmed for the purpose of implementing three alternative access authorization procedures consisting in:
a semi-automatic procedure according to which the locking and/or the unlocking are obtained by manual operation of the remote locking/unlocking devices (7, 8) of the remote control unit (B) within a cover zone (Zc),
an automatic procedure according to which the unlocking results from an identification of a control unit (B) by the central processing unit (4) within a zone (Zo), called the opening zone, of predefined extent around the vehicle (V), and the locking results from the absence of a control unit (B) within said opening zone,
and an intermediate procedure called a securing procedure according to which, when the locking is obtained by manual operation of remote locking devices (8) of a control unit (B) disposed in the opening zone (Zo), then the unlocking is authorized only after an operation of said unlocking devices (7) of the control unit.
